(19) United States
(12) Patent Application Publication
(10) Pub. No.: US 2005/0214452 A1
(43) Pub. Date: Sep. 29, 2005

(54) Method and apparatus for depositing material with high resolution

(76) Inventors: Stephen R. Forrest, Princeton, NJ (US); Max Shtein, Princeton, NJ (US)

Correspondence Address: KENYON & KENYON, 1500 K STREET NW, SUITE 700, WASHINGTON, DC, 20005, US

(21) Appl. No.: 10/810,853

(22) Filed: Mar. 29, 2004

(51) Int. Cl. C09K 7/00

(52) U.S. Cl. 427/162

(57) ABSTRACT

A device is provided. The device includes a base, and a reservoir disposed in the base. The reservoir is defined by a cladding and the base, and has an opening with a largest dimension of about 200 nm or less, more preferably 100 nm or less, and most preferably 60 nm or less. A material may be disposed within the reservoir. The base may be attached to a position control apparatus that may control the position of the base with an accuracy on the order of nanometers. The position control apparatus may include an atomic force microsope and/or a near field scanning optical microscope. The base may also be coupled to an energy application apparatus that may apply energy to the material. The device may be used to deposit material onto a substrate with a very high resolution, on the order of a few molecules across. The device may also be used to remove material from a substrate with a very high resolution by transmitting energy through the base. A device used for such removal may or may not include a reservoir.

### FIELD OF THE INVENTION

The present invention relates to electronic devices, and more specifically to a method and apparatus for fabricating such devices with features as small as several molecules across.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be an fluorescent or phosphorescent small molecule emitter. A dendrimer may be a “small molecule,” and it is believed that all dendrimers currently used in the field of OLEDs are small molecules.

Early methods of patterning organic materials involved the deposition of organic materials through a mask. The organic materials may be deposited through an “integrated” mask which is attached to the substrate on which the device is being fabricated, as disclosed in U.S. Pat. No. 6,596,443, issued on Jul. 22, 2003, which is incorporated by reference in its entirety. Or, the organic materials may be deposited through a shadow mask that is not integrally connected to the substrate, as disclosed in U.S. Pat. No. 6,214,631, issued on Apr. 10, 2001, which is incorporated by reference in its entirety. However, the resolution that may be achieved with such masks is limited due to a number of factors, including the resolution to which a mask may be reliably fabricated, the buildup of organic material on the mask, and the diffusion of organic material in between the mask and the substrate over which it is being deposited.

As used herein, “top” means furthest away from the substrate, while “bottom” means closest to the substrate. For example, for a device having two electrodes, the bottom electrode is the electrode closest to the substrate, and is generally the first electrode fabricated. The bottom electrode has two surfaces, a bottom surface closest to the substrate, and a top surface further away from the substrate. Where a first layer is described as “disposed over” a second layer, the first layer is disposed further away from substrate. There may be other layers between the first and second layer, unless it is specified that the first layer is “in physical contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

### SUMMARY OF THE INVENTION

A device is provided. The device includes a base, and a reservoir disposed in the base. The reservoir is defined by a cladding and the base, and has an opening with a largest dimension of about 200 mn or less, more preferably 100 nm or less, and most preferably 60 nm or less. A material may be disposed within the reservoir. The base may be attached to a position control apparatus that may control the position of the base with an accuracy on the order of nanometers. The position control apparatus may include an atomic force microsope and/or a near field scanning optical microscope. The base may also be coupled to an energy application apparatus that may apply energy to the material. The device may be used to deposit material onto a substrate with a very high resolution, on the order of a few molecules across. The device may also be used to remove material from a substrate with a very high resolution by transmitting energy through the base. A device used for such removal may or may not include a reservoir.

### BRIEF DESCRIPTION OF THE DRAWINGS

FIG. 1 shows a partially fabricated device in accordance with an embodiment of the invention.

FIG. 2 shows a fully fabricated device in accordance with an embodiment of the invention.

FIG. 3 shows a cross section of FIG. 2 across an opening on the tip of a reservoir.

FIG. 4 shows an apparatus incorporating the device of FIG. 2 that may be used to deposit organic material with a very high degree of accuracy.

### DETAILED DESCRIPTION

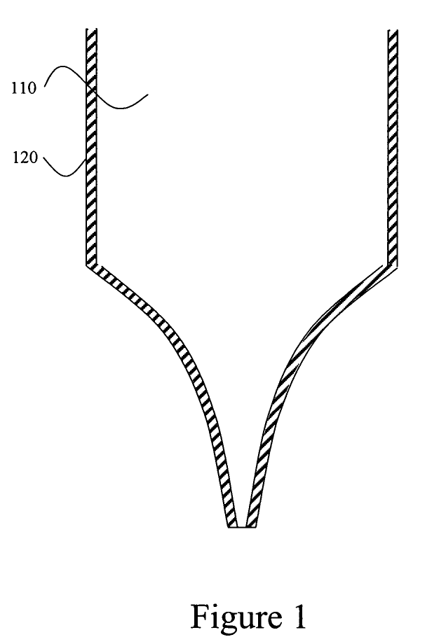

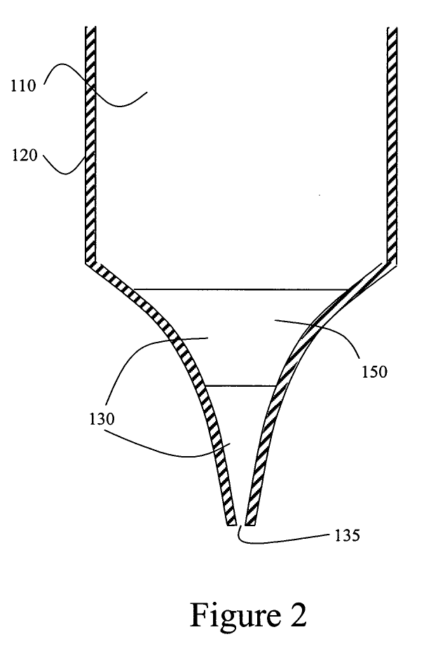

FIGS. 1 and 2 illustrate a process for fabricating a device for depositing organic materials in accordance with an embodiment of the invention. A base 110 having a tip with a very small largest dimension is made. Preferably, the dimension is about 50 nm or less. Depending upon the size of the feature that will be fabricated with the device, a different dimension may be used. One structure suitable for use as a base is a near field scanning optical microscope (“NSOM”) tip. NSOM or atomic force microscopy (“AFM”) tips suitable for use as a base may be obtained commercially from Veeco Instruments, Inc. of Freemont, Calif. or Nanonics Imaging Ltd. of Jerusalem, Israel. One method of making base 110 is to pull an optical fiber. Any optical fiber having an end that is narrowed by pulling may be referred to as a “pulled fiber.” Base 110 is then coated with a cladding 120. Preferred cladding materials include metals and metal oxides. Gold is a preferred cladding material. Preferred methods for coating the cladding onto the base include sputtering and thermal evaporation. “Cladding” is coated directly onto the base, as opposed to something such as a pipette that may be attached to the base, but would be much bulkier than cladding, less intimitely attached, and may not have desired optical and/or other properties. The fabrication and coating of a tip are described in Kurihara et al, “Microscale Fiber-Optic Chemical and Biochemical Sensors Based on NSOM Technology,” Analytical Sciences 2001, vol. 17 supplement, pp. i433-i436, Japan Society for Analytical Chemistry (“Kurihara”), which is incorporated by reference in its entirety. The cladding material is then removed from the tip of base 100. Preferred methods for removing the cladding include snapping off the very end of the tip, gentle abrasion, and/or dipping the tip into an etchant that etches the cladding material. After the cladding has been removed from the tip of base 110, the partially fabricated device appears as illustrated in FIG. 1.

A portion of the base is then removed from under the cladding to form a reservoir 130 having an opening 135. The reservoir is therefore defined by the cladding and the remaining portions of the base. A preferred method for removing a portion of the base is to apply an etchant that preferentially etches the material of base 110 as compared to the material of cladding 120. A preferred combination of materials and etchant is a glass base 11 0, a gold cladding 120, and HF etchant. HF etches glass but not gold. After the etchant has been removed, a material 150 may be inserted into the reservoir. Material 150 may be inserted using a variety of different methods. Capillary action is preferred for liquid materials, pressing may be used for fine granular materials, electrostatic inserion may be used for fine granular materials and vapor deposition may be used for sublimable or evaporable materials. Other methods may also be used. Preferred materials 150 include organic materials that may be used to fabricate OLEDs, as well as other materials such as Ge and Si. Various other materials may also be used. After material 150 has been inserted, the device appears as illustrated in FIG. 2.

Using a base having a metal or metal oxide cladding is particularly advantageous, because it allows NSOM or AFM techniques to be used to position the base with a high degree of accuracy relative to features on the surface of a substrate. Specifically, the metal or metal oxide coating is particularly durable for use in AFM, and metal or metal oxide provides an appropriately opaque rim for the opening for use in NSOM. In addition, cladding provides a way to achieve a reservoir without bulky additional components that may add significant mass and make maneuvering the base more difficult.

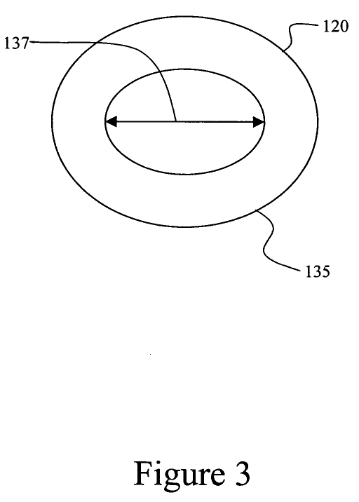

FIG. 3 shows a cross section of FIG. 2 across opening 135. The term “largest dimension” as used herein refers to the longest line that may be drawn across the interior of opening 135. Line 137 illustrates an example of the “largest dimension.” In a preferred embodiment, opening 135 is a circle and the largest dimension is the diameter of the circle. For nano-printing that takes full advantage of the positioning accuracy and resolution that may be acheived with NSOM and/or AFM techniques, the largest dimension is preferably about 60 nm or less. However, larger dimensions may be used, such as 100 nm or 200 nm.

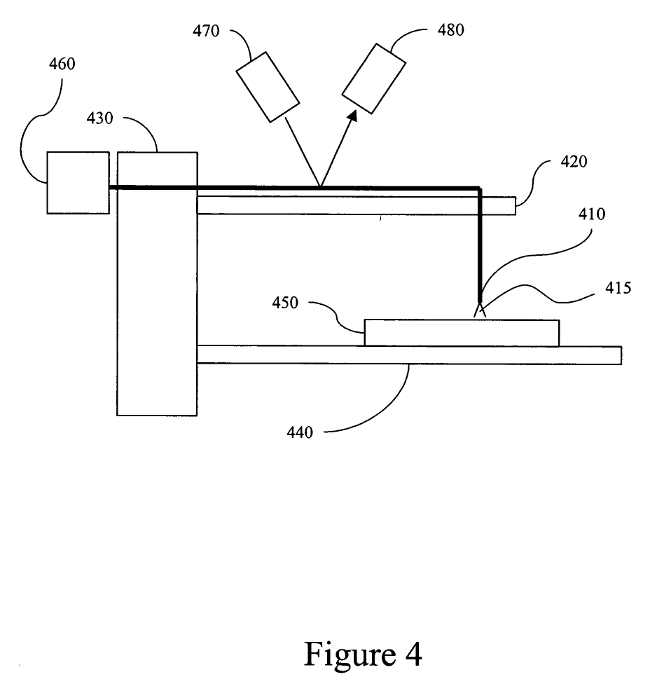

FIG. 4 shows a device that incorporates the device of FIGS. 1 and 2. The device of FIG. 4 may be used to deposit organic features with dimensions on the order of a few molecules across. A deposition apparatus 410, illustrated as a line in FIG. 4, may have a structure similar to the device illustrated in FIG. 2, including a reservoir having an opening. In a preferred embodiment, deposition apparatus 410 is an optical fiber that has been pulled, clad, and provided with a reservoir as described with respect to FIGS. 1 and 2. Deposition apparatus 410 is attached to a position control apparatus. In one embodiment, the position control apparatus includes an arm 420, a positioning device 430, and a substrate holder 440. The position control apparatus may be capable of controlling the position of deposition apparatus 410 relative to a substrate 450 to within 5 nanometers in all directions, including vertical. In a preferred embodiment, the position control apparatus incorporates piezoelectric components. For example, arm 420 may incorporate one or more piezoelectric crystals. The position control apparatus may also incorporate less precise components, such as a stepper motor, which are used for coarse positioning prior to the finer positioning that may be achieved with piezoelectrics or similar components. For example, position control device 420 may incorporate one or more stepper motors. The position control apparatus is not necessarily limited to the configuration illustrated and described with respect to FIG. 4. Any apparatus capable of controlling the position of deposition apparatus 410 relative to substrate 450 with the desired degree of accuracy may be used. Preferably, an accuracy of 5 nm may be achieved, and more preferably, an accuracy approaching 1 nm may be achieved. Such accuracy may be achieved using known NSOM or AFM apparati. Depending upon the features to be deposited, a less accurate positioning device may be adequate. For example, to deposit organic wires, a positioning accuracy of 5 nm or even 10 nm may be suitable.

FIG. 4 illustrates a simplified positioning device 430. Any suitable positioning device may be used, for example those known in connection with AFM or NSOM microscopes. The atomic force microscope is a scanned-proximity probe microscope. The prototype AFM works by measuring a local property—such as height, or hardness—with a probe or “tip” placed very close to the sample. The small probe-sample separation (on the order of the instrument's resolution, usually around nanometers or angstroms) makes it possible to take measurements over a small area. To acquire an image the microscope raster-scans the probe over the sample while measuring the local property in question. The resulting image resembles an image on a television screen in that both consist of many rows or lines of information placed one above the other. Unlike traditional microscopes, AFM does not use lenses, so the size of the probe rather than diffraction effects generally limit their resolution. An NSOM has the basic structure of an AFM, it measures the local optical properties as well as height of the sample. With further modification of the system, an NSOM is able to achieve nanometer-size fabrication. In embodiments of the present invention, it is possible to fabricate a deposition apparatus 410 having properties that make it suitable for use in an AFM or NSOM, so that AFM or NSOM techniques may be used to position the deposition apparatus relative to features on a substrate. For example, metal cladding on the deposition apparatus may be used for techniques that rely on a conductive tip, and/or a deposition tip may be made from an optical fiber for optical techniques.

A laser 470 and a photodetector 480 may be used to determine when and how much deposition apparatus 410 moves. Light from laser 470 is reflected off of deposition apparatus 410, or arm 420, or some other appropriate part of the device. When deposition apparatus 410 moves in the vertical direction, arm 420 (for example) is deflected, resulting in a change in the position of the light detected by photodetector 480. This type of position sensing is particularly useful for embodiments that use an AFM or NSOM apparati. Specifically, AFM embodiments may involve touching to tapping the tip of deposition apparatus 410 gently to the surface of substrate 450 and moving deposition apparatus 410 in horizontal directions. By measuring the vertical deflection of the deposition apparatus, the surface of substrate 450 may be mapped. NSOM is similar to AFM, but may also involve using light emitted and/or gathered through an opening (see, e.g., opening 135 of FIG. 2) in deposition apparatus 410. Normally, the best resolution that can be resolved with visible light is on the order of 200 nm. But, by using a small opening to transmit the light, for example, 100 nm, 60 nm, or less, with an opaque material defining the opening, better resolutions may be obtained. Thus, the same aperture that is used to expel material onto the substrate may also be used to assist in the positioning of deposition apparatus 410.

The device of FIG. 4 may also include an energy application apparatus 460. Energy application apparatus may apply energy to an organic material located in a reservoir of deposition apparatus 410 (as illustrated, for example, in FIG. 2). In a preferred embodiment, deposition apparatus 410 is based on an optical fiber, and energy application apparatus is a light source, preferably a laser, that shines light through the optical fiber into the reservoir. The laser source preferably emits light having a wavelength near an absorption peak of the material being sublimed, such that the light energy is efficiently absorbed by the material. Other energy application apparati may be used. For example, energy application apparatus 460 may be a heat source that heats deposition apparatus 410, including an organic material located in the reservoir via heat conduction along deposition apparatus 410. An energy application apparatus 460 may be described as being “coupled” to a base of deposition apparatus 410 if the energy application apparatus is able to apply energy to the base. For example, a laser that shines laser light into an optical fiber, which may have several splices or other interfaces, such that the laser light ultimately reaches the base, is “coupled” to the base. Similarly, a heat source that applies heat that is conducted to the base is coupled to the base. The base may be considered “optically connected” to a light source if light from the light source may be directed reliably at the base. For example, a laser that directs light through a number of optical fibers and splices to the base may be considered optically coupled to the base. Alternately, or in addition, apparatus 460 may be adapted to send and/or receive light signals for use in an NSOM apparatus.

When energy is applied to deposition apparatus 410, material is ejected through opening 235 (not illustrated directly in FIG. 4, see FIG. 2) and deposited on substrate 450. This deposition is illustrated as vapor phase organic material 415 in FIG. 4. The distance between a tip of deposition apparatus 410 and substrate 450 is preferably about 0.5-5 nm, more preferably about 1-3 nm, and most preferably about 1-1.5 nm. Smaller distances may result in undesirable contact between the tip and substrate 450. Larger distances may result in an undesirably large spreading of organic material between the tip and the substrate. The tip of deposition apparatus 410 may be described as “adjacent to” the substrate when the distance is within the ranges described, or other distances that do not result in too much spreading or an undesirably large chance of contact with the substrate. By choosing an appropriate energy, the material being deposited may be vaporized slowly, such that the vapor pressure at the temperature generated by the applied energy determines the amount of material expelled from the opening. As a result, the material may be deposited over a period of time and many features may be fabricated without reloading the deposition apparatus with material.

In an embodiment of the invention, a device similar to that shown in FIG. 4 may be used to remove organic (or inorganic) material that has been previously deposited. For such an application, “deposition apparatus” 410 would be used to remove material as opposed to depositing material, and may be referred to as a “removal apparatus.” Such a removal apparatus may appear as illustrated in FIG. 1, with or without cladding 120. Preferably, the removal apparatus does not have a reservoir, although it may have a reservoir. The position of the removal apparatus relative to a substrate may be controlled as illustrated in FIG. 4. The removal apparatus may be used to remove organic material from a substrate by the application of energy. For example, a laser beam may be directed through the base at the substrate to ablate material previously deposited on the substrate.

In another embodiment, “deposition apparatus” 410 may be used to deposit a material that modifies a previously deposited layer. For example, a material that chemically modifies the pre-existing film may be deposited through deposition apparatus 410. Subsequent processes that do not involve the use of a deposition apparatus may be used to further modify or even remove the regions onto which material has been deposited, the regions onto which material has not been deposited, or both but in different ways.

Various embodiments of the invention may be used, for example, to draw very high resolution wires, or to create other optical, electronic, or mechanically functionalized regions with a very high resolution. Features deposited using the present invention may have a resolution of 4-5 molecules across, or about 5 nm or less. The resolution depends primarily on the size of the opening in the reservoir, and the distance between the opening and the substrate over which the material is being deposited.

Preferred embodiments of the invention may be used to deposit and/or remove organic materials. However, the invention is not limited to organic materials only, and may also be used to deposit and/or remove inorganic materials as well.

Although specific embodiments have been described, other embodiments may also be used. For example, it is known to manufacture metal wires having very fine tips for use in a scanning tunneling microscope by hanging the wire in an etchant that slowly dissolves the wire, until a portion falls away leaving a very sharp tip. Such a wire may also be used in connection with the present invention, where a cladding material is selected such that there is an etchant that preferentially attacks the metal wire over the cladding material to form a reservoir. The preferred method of applying energy to organic material disposed within the reservior in such an embodiment is the application of heat to the wire.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

1. A device, comprising:
a base;
a metal or metal oxide cladding coated on the base;
a reservoir defined by the base and the cladding, wherein the reservoir has an opening, and wherein the largest dimension of the opening is less than about 200 nm.

2. The device of claim 1, wherein the reservoir comprises a volume removed from the base inside the cladding.

3. The device of claim 1, further comprising a material disposed within the reservoir.

4. The device of claim 3, wherein the material disposed within the reservoir is an organic material.

5. The device of claim 3, wherein the material disposed within the reservior is silicon or germanium.

6. The device of claim 1, wherein the cladding is gold.

7. The device of claim 1, wherein the largest dimension of the opening is less than about 100 nm.

8. The device of claim 7, wherein the largest dimension of the opening is about 60 nm or less.

9. The device of claim 1, further comprising a position control apparatus attached to the base.

10. The device of claim 9, wherein the position control apparatus further comprises comprises a piezoelectric component.

11. The device of claim 9, wherein the position control apparatus further comprises an atomic force microscope apparatus.

12. The device of claim 9, wherein the position control apparatus further comprises a near-field scanning optical microscope apparatus.

13. The device of claim 9, further comprising an energy application apparatus coupled to the base.

14. The device of claim 13, wherein the base comprises an optical fiber, and the energy application apparatus comprises a light source optically connected to the optical fiber.

15. A method of manufacturing a device, comprising:
obtaining a base having a tip;
coating the tip of the base with a cladding material;
removing a portion of the base from under the cladding material to create a reservoir, wherein the reservoir has an opening with a largest diameter of about 200 nm or less.

16. The method of claim 15, wherein the base is obtained by pulling an optical fiber.

17. The method of claim 15, wherein the cladding material is a metal.

18. The method of claim 15, wherein the cladding material is a metal oxide.

19. The method of claim 15, wherein the opening has a largest diameter of about 100 nm or less.

20. The method of claim 15, wherein the opening has a largest diameter of about 60 nm or less.

21. The method of claim 15, wherein the portion of the base is removed by etching.

22. A method of depositing a material, comprising:
obtaining a base including a reservoir having an opening with a largest dimension less than about 200 nm, wherein a material is disposed within the reservoir, and wherein the reservoir is defined by a part of the base and a cladding on the base;
positioning the opening in the reservoir adjacent to a substrate;
applying energy to the material such that some of the material is expelled through the opening and deposited on the substrate.

23. The method of claim 22, wherein the base comprises an optical fiber, and the applied energy is light applied to the organic material through the optical fiber.

24. The method of claim 22, wherein the applied energy is heat.

25. The method of claim 22, wherein the material is an organic material.

26. The method of claim 22, wherein the material is silicon or germanium.

27. The method of claim 22, wherein the material is deposited in a pattern having features with a resolution of less than about 5 nm.

28. The method of claim 22, wherein the opening is positioned using an atomic force microscope technique, and the base acts as an atomic force microscope tip.

29. The method of claim 22, wherein the opening is positioned using a near-field scanning optical microscope technique, and the base is used to transmit light for use in the near-field scanning optical microscope technique.

30. A method of fabricating a device, comprising:
obtaining a substrate having a material disposed thereon;
using a position control apparatus to position a base adjacent to the material;
removing the material adjacent to the base by applying energy through the base.

31. The method of claim 30, wherein the base is covered with a cladding.

32. The method of claim 30, wherein the position control apparatus is an atomic force microscope technique, and the base acts as an atomic force microscope tip.

33. The method of claim 31, wherein the position control apparatus is a near field scanning optical microscope, and the base is used to transmit light for use in the near-field scanning optical microscope.
